(19) United States
(12) Patent Application Publication
(10) Pub. No.: US 2005/0051932 A1
(43) Pub. Date: Mar. 10, 2005

(54) Hydraulic composite molding and hydraulic molded products

(76) Inventor: Dennis M. Danzik, Scottsdale, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/656,747

(22) Filed: Sep. 4, 2003

(51) Int. Cl. B29C 70/00

(52) U.S. Cl. 264/511; 264/512; 264/257; 264/313

(57) ABSTRACT

Composite hydraulic molding that results in low cost, lightweight and strong composite structures. In accordance with the process, reinforcing material, which may be a mat and/or fabric of high strength filament, is placed in a mold, an inflatable tube 34 is placed over the reinforcing material and further reinforcing material, which may be integral with the reinforcing material under the inflatable tube, is placed over the inflatable tube. The mold is closed, and a thermosetting resin is pumped into the mold. The inflatable tube 34 is then inflated with a liquid, saturating the reinforcing material and forcing any air in the mold out of one or more bleeder holes in the mold. After curing the resin, the inflatable tube 34 is deflated and removed and the mold opened to remove the molded part. Various embodiments and additional features are disclosed.

### BACKGROUND OF THE INVENTION

1. Field of the Invention

The present invention relates to the field of composite molding processes and composite molded products.

2. Prior Art

Composite molding processes and composite molded products are well known in the prior art, and in some applications have substantially displaced prior fabrication techniques and materials because of their many superior properties compared to prior art materials. By way of example, most new pleasure boats are made of fiber reinforced resins using hand lay-up molding processes. While these processes are labor intensive, and thus relatively expensive, the fabrication processes they displaced were also relatively labor intensive and expensive, with the superior properties of the composite molded product usually dictating its use.

In other applications such as in certain structural members, including columns, beams and utility poles, and in more complex structures, composite molded structures are not yet frequently used because of their cost. By way of example, in the case of ordinary utility poles, wooden poles have most frequently been used because of their relatively low cost and reasonable useful life. Other types of poles have also been used, such as steel and concrete, because of certain superior characteristics to wooden poles, though their cost prevents their displacement of wooden poles except in applications where their special characteristics, such as uniform aesthetic appearance, are of particular concern.

More recently, composite columns and beams, such as may be used for utility poles and in construction applications, have been produced. Such structural members can offer many advantages over steel, concrete and wood, though the cost of such prior art structural members has limited their application. For instance, composite utility poles are of uniform dimension and appearance, are light weight, immune from attack by birds and insects, non-toxic, non-conductive electrically, can be made to weather well, etc. However, cost remains an impediment to their more widespread use.

### BRIEF DESCRIPTION OF THE DRAWINGS

FIG. 1 is a perspective view of an exemplary mold suitable for fabricating poles such as utility poles, and columns and beams for buildings and the like in accordance with the present invention.

FIG. 2 is a perspective view of the mold of FIG. 1 after one or more layers of a high strength filament mat and/or fabric is laid in the bottom half of the mold.

FIG. 3 is a further prospective view of the mold after an inflatable tube has been laid over the mat and/or fabric shown in FIG. 2.

FIGS. 4a and 4b illustrate an exemplary removable seal for one or both ends of the inflatable tube.

FIG. 5 illustrates the folding of the mat and/or fabric layers over the inflatable tube.

FIG. 6 illustrates the injection of resin in the mold after the mold has been closed and sealed.

FIGS. 7a, 7b and 7c illustrate an exemplary fluid control, pumping and storage system for a fluid for controlled inflation and deflation of the inflatable tube.

FIG. 8 illustrates an exemplary cured pole after mold opening and inflatable tube removal.

FIGS. 9a and 9b illustrate the additional placement of a heavy cord-like member in the mold, and a local cross section of a finished pole illustrating the reinforcing ring so formed, respectively.

FIGS. 10a and 10b illustrate the placement of a spacer and one or more additional layers of mat and/or fabric in the mold, and a local cross section of a finished pole illustrating the reinforcing ring so formed, respectively.

FIG. 11 illustrates a local cross section of a finished pole taken through a reinforcing ring formed by placement of a spacer material in a sock of reinforcing material in the mold.

FIG. 12 illustrates an exemplary tapered pole with equally spaced reinforcing rings therein.

FIG. 13 illustrates an exemplary untapered pole with unequally spaced reinforcing rings therein.

FIG. 14 illustrates an exemplary alternate form of molded product that may be manufactured using the present invention process.

FIG. 15 illustrates an exemplary insert that may be molded into a product manufactured in accordance with the present invention.

FIG. 16 is a face view of an exemplary pocket of reinforcing material that may be used to better bind the insert in the finished product and to protect the inflatable bladder from any sharp edges on the insert.

### DETAILED DESCRIPTION OF THE PREFERRED EMBODIMENTS

In the following description of preferred methods of practicing the present invention, a basic process or method will be described, together with exemplary equipment for practicing the method and for the manufacture of specific types of products, after which exemplary variations and improvements will be described for the manufacture of the same or similar products. Thereafter, the method will be described with respect to manufacture of exemplary products of substantially different characteristics and configurations.

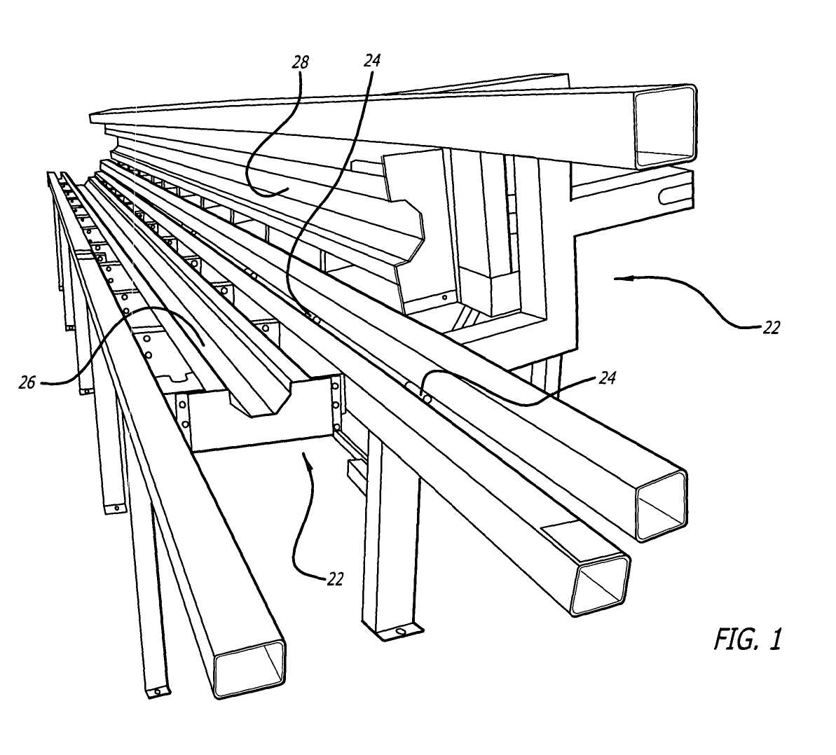

Referring now to FIG. 1, an exemplary mold suitable for fabricating poles such as utility poles, and columns and beams for buildings and the like, may be seen. In the particular mold shown, two mold halves, generally indicated by the numerals 20 and 22, may be seen. These mold assemblies are hinged together along one side thereof by hinges 24 so as to be openable, as shown in FIG. 1, and closable, as shown in some of the later Figures to be described. Each mold assembly in this embodiment includes a mold half 26 and 28, that in this example comprises a mold for an eight sided pole. (The word pole is used in the general sense herein to include columns, beams and other structural members.) The mold, and thus the outer dimensions of the pole to be fabricated thereby, may be of uniform cross-section, may diminish in cross section linearly or nonlinearly along its length, or may have sections of increased and decreased cross-sectional areas, or of non symmetrical cross sections, as desired. In that regard, while a symmetrical cross-section will normally be desired for aesthetic purposes, certainly this is not a limitation of the present invention. Similarly, round, oval or other cross-sections having straight or curved axes may readily be fabricated by the present invention method.

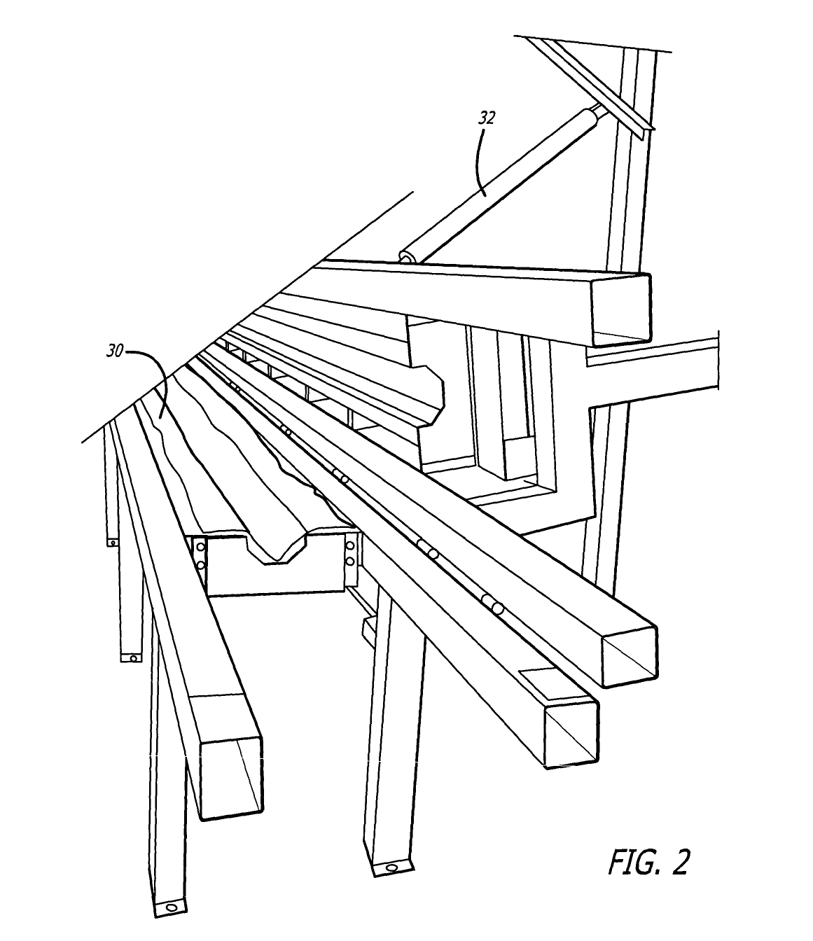

The fabrication of a pole may begin with the coating of the mold halves with a mold release, typically as by spraying, as is well known in the composite molding art. Thereafter, if desired, a layer of gel coat may be applied, again typically by spraying, for both weathering and aesthetic purposes. The application of a gel coat is, in general, optional, as ultraviolet light resistance, etc. may not be required in a particular application, may be adequately provided by the resin or resin additive used, or alternatively, coatings for aesthetic and weathering purposes may be applied after the pole is fabricated. In any event, after the gel coat is applied, if used, one or more layers of a high strength filament mat and/or fabric 30 is laid in the bottom half of the mold, as shown on FIG. 2. Preferably this or these mats and/or fabrics have a width somewhat greater than the circumference of the finished pole so that the edges thereof will overlap in the finished pole, and at least one of the mats or fabrics has a length corresponding to the length of the finished pole, or slightly greater than the length of the finished pole to allow for trimming of the ends of the pole. In that regard, one of the advantages of the present invention is that mats and/or fabrics having greater thicknesses along their length, or additional layers of mats and/or fabrics may be used to provide additional strength in the areas of the pole requiring additional strength.

In the case of a utility pole, the bending moment is typically greatest adjacent the base of the pole and diminishes along its length, suggesting the use of additional high strength filament, such as by thicker mats and/or fabrics in that area, or alternatively, additional layers of mats and/or fabrics in designated areas. In areas where more than one layer of mat and/or fabric is used, preferably the layers will be somewhat laterally offset from each other so that the areas created by the overlap of the layers will be spaced circumferentially from each other in the finished pole.

Also visible in FIG. 2 is one of typically a plurality of hydraulic cylinders 32 used to open and close the mold. These cylinders operate between the lower frame that the lower mold half is attached to, and the upper frame that is hinged to the lower frame and supports the upper mold half.

After the mat and/or fabric is put in place in the lower half of the mold, an inflatable tube 34 is laid over the fabric so as to extend somewhat beyond the ends of the mold, as shown in FIG. 3. In this embodiment, the inflatable tube 34 is preferably a gum rubber tube, as the gum rubber will generally not stick to the composite molded product being fabricated, though other elastic materials may be used as desired. The ends of the inflatable tube 34 may take various configurations, though for purposes of specificity herein, a few of the typical possible configurations will be described. These various configurations are intended to allow the ingress and egress of an incompressible fluid into and out of the inflatable tube 34 in a controlled manner from one end of the inflatable tube, or alternatively, from both ends of the inflatable tube.

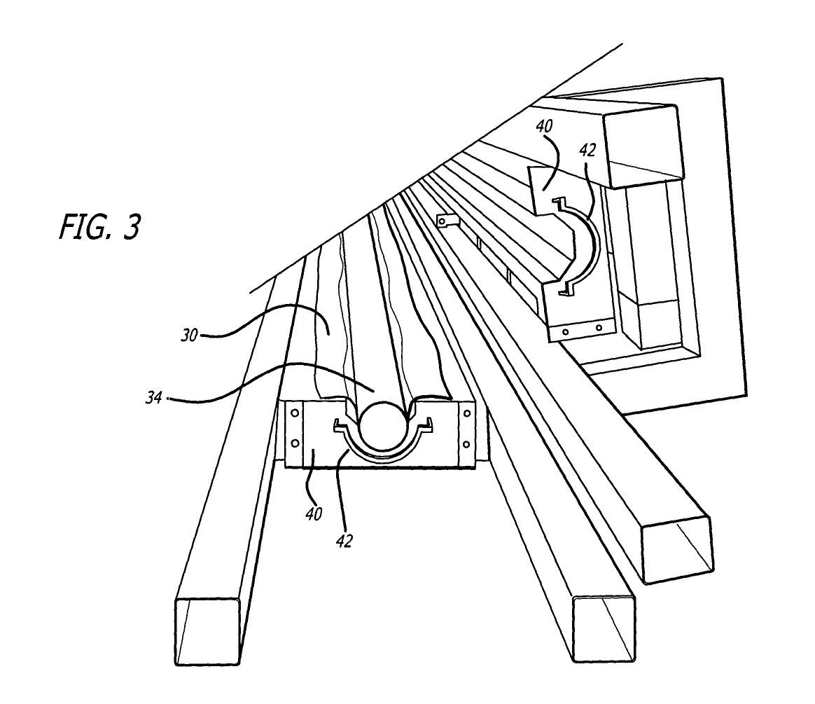

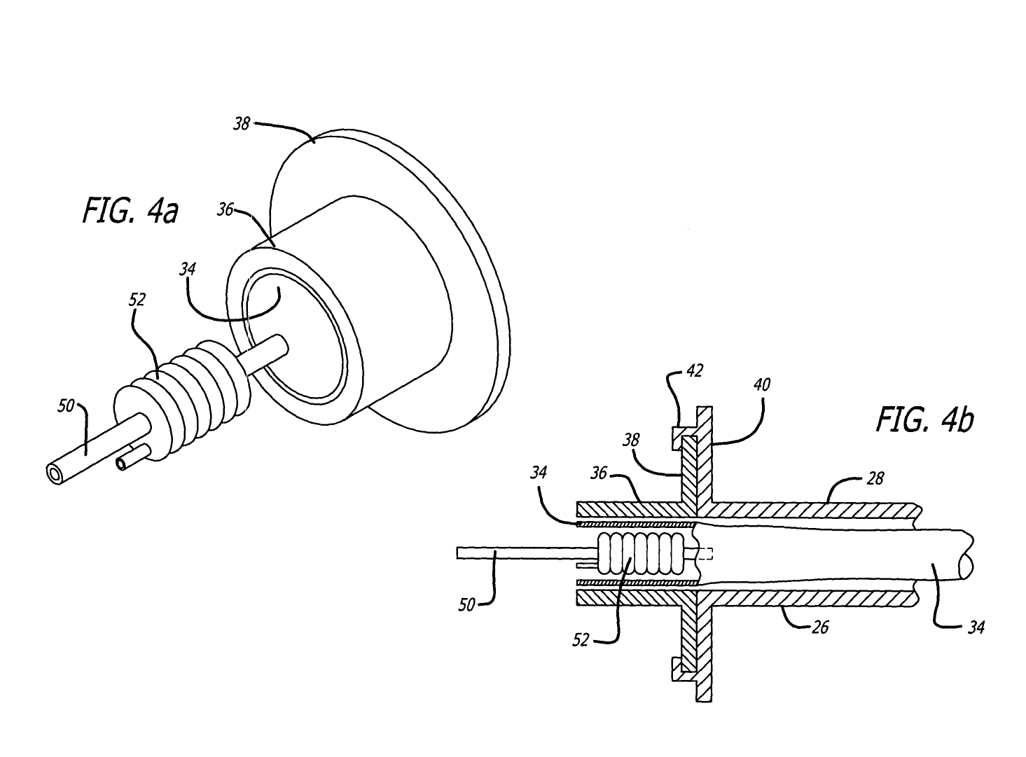

One way this has been accomplished is to provide a rigid tubular member 36 (see FIGS. 4a and 4b) with a flange 38 thereon, the tubular member 36 having an inside diameter (or other cross-sectional shape) equal to or approximately equal to the adjacent inside diameter of the mold (26 and 28) when the mold is closed. In use, the end of the inflatable tube 34 extends inside the tubular member 36 (FIG. 4a) with the flange 38 being retained relative to the closed mold, such as by an annular groove between the ends 40 of the mold assembly and members 42 spaced therefrom. This is shown in cross-section in FIG. 4b.

Also at this time, mat and/or fabric layer(s) 30 are folded over the inflatable tube 34, as shown in FIG. 5, so that the two edges of each layer (frequently only one layer is used) overlap. Thereafter the mold is closed using the hydraulic cylinders 32 (FIG. 2) and locked in the closed position using hydraulic cylinders, automatic or manually operated clamps, or a combination of these or other means. Closure of the mold retains the flanges 38 (FIG. 4a) relative to the end of the mold (FIG. 4b) at one or both ends of the mold. At at least one end of the mold, a pipe 50 (FIG. 4a) having a small inflatable donut shaped stopper 52 thereon is inserted into the free end of the inflatable tube 34 within the rigid cylindrical section 36. The inflatable stopper 52 is then inflated to seal with respect to the inner diameter of the inflatable tube 34, in turn forcing the outer diameter of the inflatable tube to seal against the rigid cylindrical section 36. In that regard, flange 38 is adapted to seal against the ends of the two mold halves, with the mold halves themselves having a flexible seal to seal with respect to each other so that uncured resin will not leak from these areas of the mold in later stages of the process. (In one embodiment, flange 38 is held against the ends of the mold assemblies by screws with handles on them for quick tightening and release.)

If fluid is to be injected into the end of the inflatable tube 34 from both ends, the same exemplary connection shown in FIG. 4a may be used at both ends of the inflatable tube. In many applications, however, a single fluid connection to the inside of the inflatable tube 34 is all that is required, in which case the other end of the inflatable tube may be permanently closed. In that regard, preferably such permanent or semi-permanent closure seals with respect to the respective end of the mold to avoid leakage of uncured resin in that area, and to longitudinally confine the inflatable tube 34 so that its expansion on inflation is substantially radial and not substantially axial.

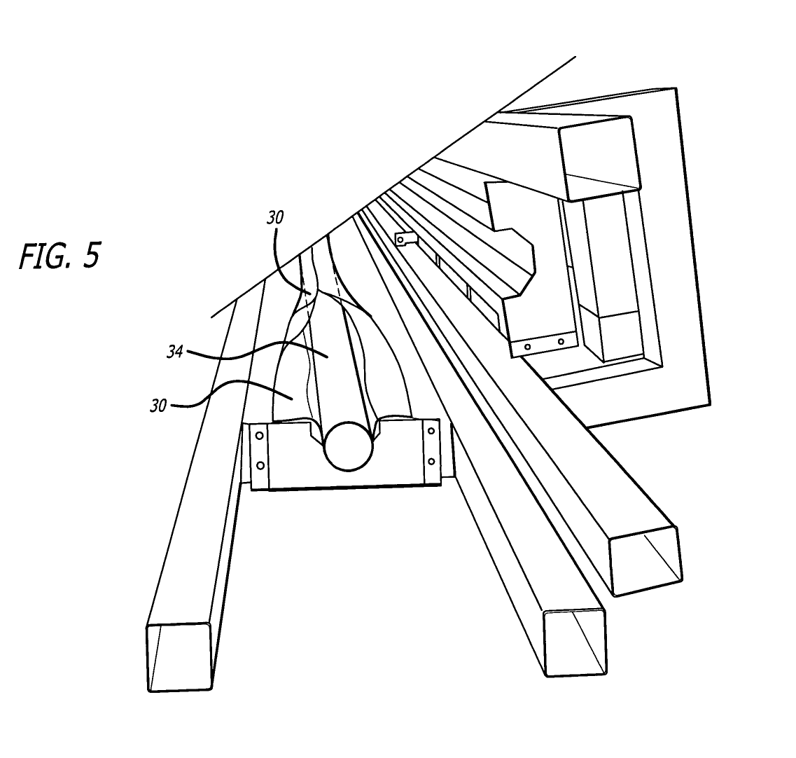

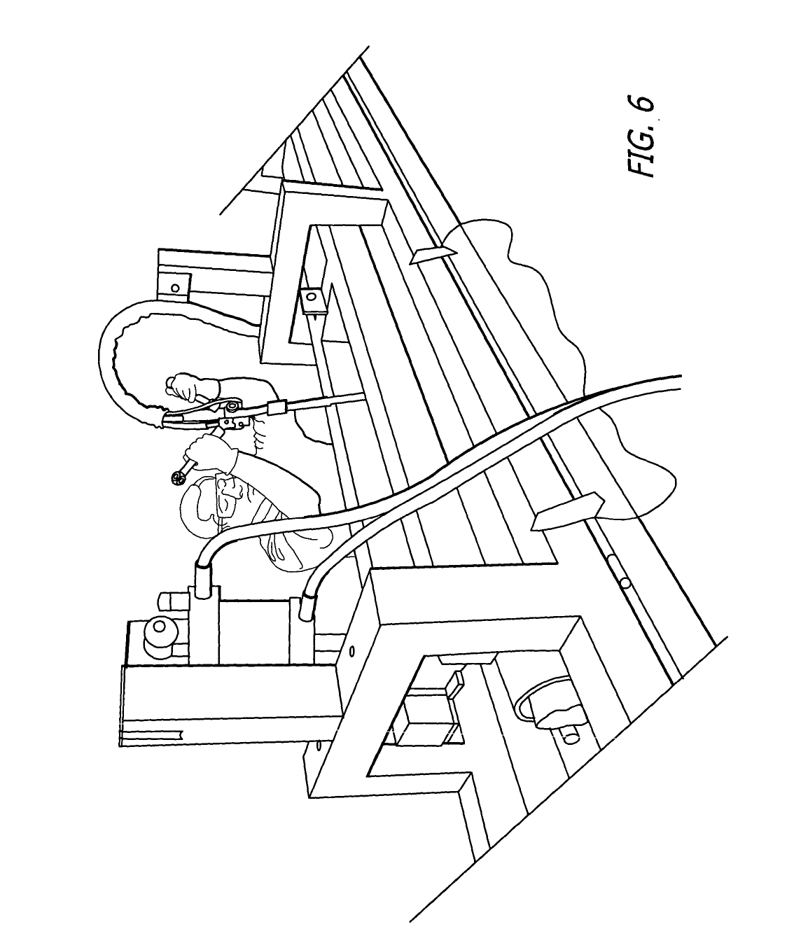

The next step in the process is to inject a resin, typically a thermosetting resin, into the mold at one or more locations along the mold as illustrated in FIG. 6. Preferably a fixed (measured) amount of resin (typically, but not necessarily a resin/catalyst mix) is injected, preferably exceeding the amount of resin which will appear in the finished pole, such as just over 100%, to approximately 110%, of the resin in the finished pole. At this stage of the process, the inflatable tube 34 is sealed with respect to the mold at both ends, but is not inflated, and in fact may be partially evacuated and collapsed. Consequently, as the resin is injected, the same will puddle in the bottom mold half along the entire length of the mold, using only one or no more than a few injection sites. This, of course, fully impregnates the part of the mat and/or fabric in the resin puddle.

The next step of the process is to inflate the inflatable tube 34, preferably with an incompressible fluid, in a preferred embodiment with water of a controlled temperature. By way of a specific example, in one embodiment, water of a controlled elevated temperature is pumped into the inflatable tube 34 through pipe 50 at one end thereof to inflate the inflatable tube to the desired pressure. The inflatable tube 34 preferably is relatively uniformly inflated at a controlled rate, during which time the level of the resin puddle in the lower part of the mold will move upward as the resin is displaced by the inflating tube 34, saturating more of the mat and/or fabric. In that regard, the upper mold half is provided with small holes distributed along its length at the uppermost level of the mold cavity, such as by way of example only, approximately 3 inches apart, which holes allow the air in the mold to escape as the inflatable tube 34 is inflated, and ultimately allow the excess resin to be expelled from the mold.

For inflation purposes, the pipe 50 through which the fluid is provided to the inflatable tube 34 may extend only a short distance into the inflatable tube, or alternatively, may extend up to the full length of the inflatable tube with a plurality of openings therein to distribute the fluid along the length of the inflatable tube. Proper inflatable tube 34 inflation is generally readily achieved using a pipe which only extends a short distance into the inflatable tube 34, though a pipe running the full length of the inflatable tube may make the inflatable tube easier to handle when deflated. In any event, during inflation, when the resin level reaches the top of the mold cavity, the excess resin is expelled through the small holes in the top of the mold and collected through a manifold system for reuse in the fabrication of the next pole.

In general, the proportion of resin to high strength filament in the finished pole may be controlled by controlling the pressure used for inflation of the inflatable tube 34. In one exemplary process, the desired results have been obtained by using a water pressure of approximately 5 psi.

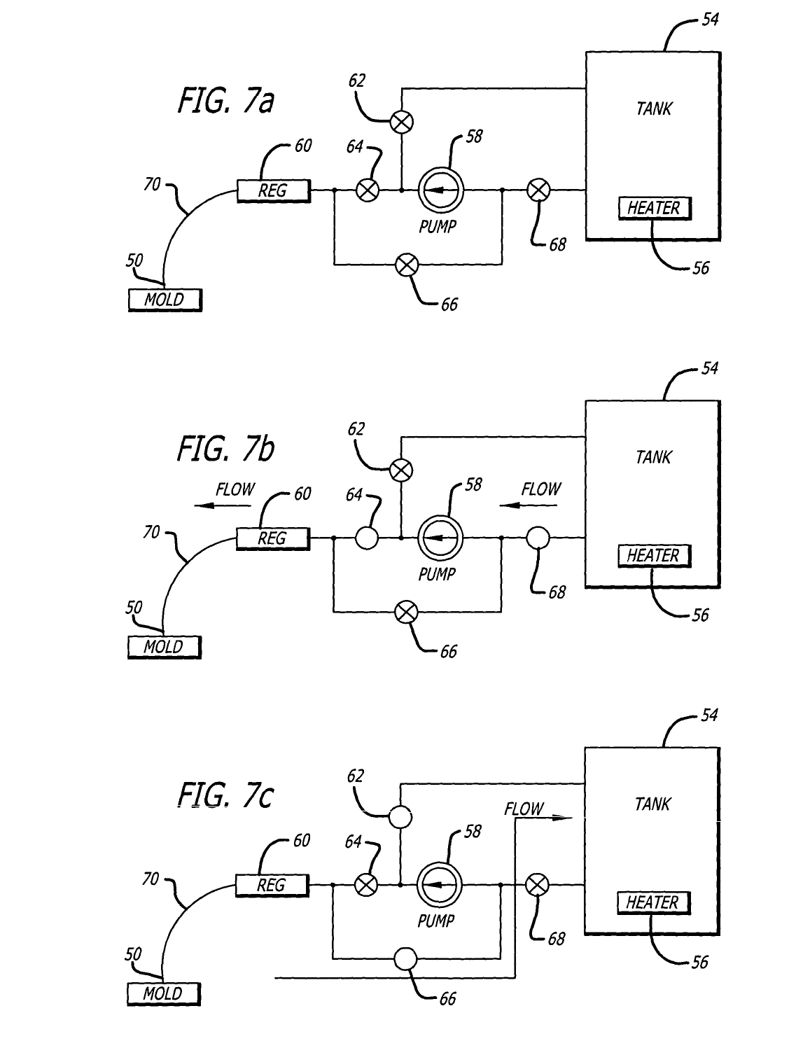

Referring to FIGS. 7a through 7c, an exemplary water supply system may be seen. A storage tank 54 with a heater 56 therein is plumbed to an assembly comprising a pump 58, a regulator 60 and four control valves 62, 64, 66 and 68. The regulator 60, in turn, is coupled through a hose 70 to pipe 50 (see FIGS. 4a and 4b) supplying the water to the inflatable tube 34 in the mold. The valves 62, 64, 66 and 68 may be solenoid operated valves operated in pairs to supply water from the tank 54 through the regulator 60 to the inflatable tube 34 in the mold, or alternatively, to withdraw water from the inflatable tube 34 in the mold through the regulator for return to the tank. In particular, for delivery of water from the tank to the mold as shown in FIG. 7b, valves 64 and 68 are open and valves 62 and 66 are closed. In FIG. 7c, valves 62 and 66 are open and valves 64 and 68 are closed so that the pump will withdraw water from the inflatable tube 34 for return to the tank.

In one embodiment, the pump 58 is a swimming pool water recirculation pump, capable of delivering a substantial pressure, or alternatively, of dropping the pressure in the inflatable tube 34 to well below atmospheric pressure when returning water to the tank. This causes the inflatable tube 34 to separate from the inside surface the molded product and to remove substantially all of the water from the inflatable tube, facilitating the easy removal of the inflatable tube from the molded product. In that regard, if one end of the tube 34 is closed, that closure may be configured so as to pass through the finished product, allowing the inflatable tube to be withdrawn from the finished product without disconnecting the water supply hose so that once air is initially expelled from the inflatable tube, air cannot reenter the inflatable tube.

In the event the inflatable tube 34 is disconnected for removal from the finished product so that air can get into the inflatable tube, one may provide some form of valve to allow air, but not water, to escape from the inflatable tube, such as by way of example a float valve connected to the top of the inflatable tube at the end opposite the end into which the water is injected. This will allow at least most of the air to be expelled from the inflatable tube 34 before closing. In that regard, while it is not necessary for the inflatable tube 34 to be perfectly free of air, it is preferable that most air be expelled from the inflatable tube for various reasons. Assuming the resin is to be cured by using a heated fluid in the inflatable tube 34 (air having too low a specific heat to the useful in this regard), a generally incompressible fluid such as water or some other alternative fluid must substantially fill the inflatable tube, both to provide the required heat capacity and the desired heat transfer to the resin. Also, a compressible fluid could slow the pressurization of the inflatable tube 34 and would be less energy efficient. Further, substantial air in the inflatable tube 34 causes excessive buoyancy of the inflatable tube in the resin puddle, which has been found to provide less desirable results.

As the inflatable tube 34 is inflated, not only does the resin level rise to fully saturate the high strength mat and/or fabric, but the overlap in the mat and/or fabric will decrease as it opens to fit tightly within the inner periphery of the mold. Once pressurized, the resin may be cured, either as a result of the heat provided by the preheated water used to pressurize the inflatable tube 34, by separate mold heaters, by RF energy, by some other technique, or by a combination of such techniques. After curing, the mold is opened, the inflatable tube 34 removed from the molded pole and the pole removed from the mold, and the mold readied for the molding of the next pole. Using heat to accelerate the curing of the resin, the excess resin expelled prior to curing can have an adequate shelf life remaining to be used in the fabrication of the next pole, as the entire molding cycle time is relatively short. Also the resin that is left in the holes in the upper mold half cures with the rest of the resin in the pole, and clings to the pole and withdraws from the holes as the mold is opened. Thus, clogging of the holes with cured resin has not been a problem.

The cured pole after mold opening and inflatable tube removal is illustrated in FIG. 8. Finishing operations for the poles will vary, depending on the application and preferences. Such operations may include trimming of the ends of the pole, and painting and/or applying a UV inhibiting layer, if not included in the molding process. Finishing operations may also include such operations as joining of two poles of the same or different lengths and of the same or different cross sectional areas to obtain a longer pole, perhaps of larger cross section at the base than at the top.

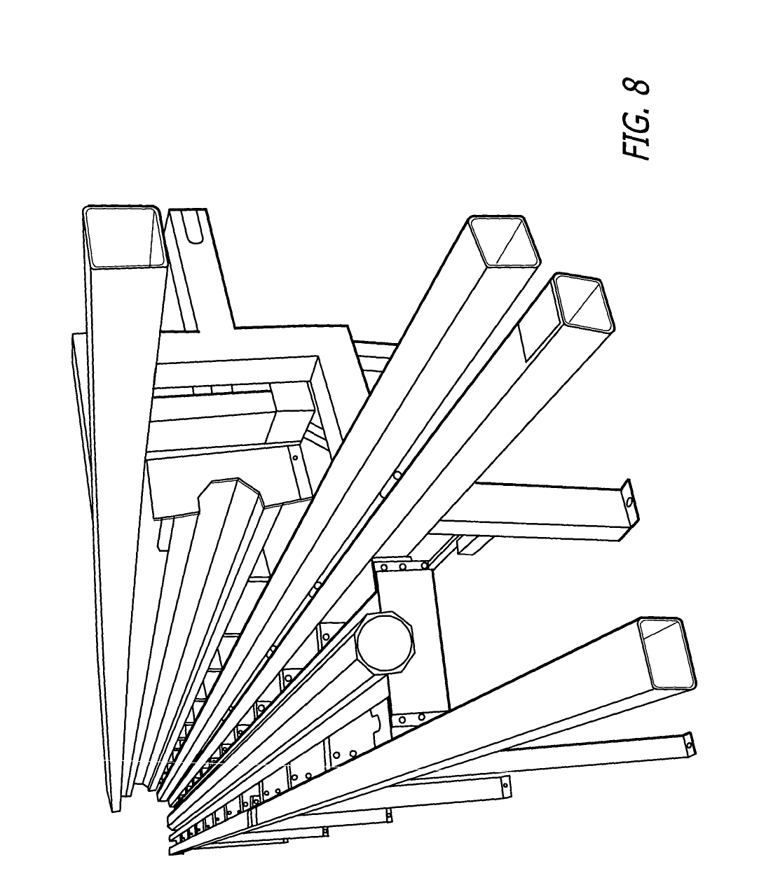

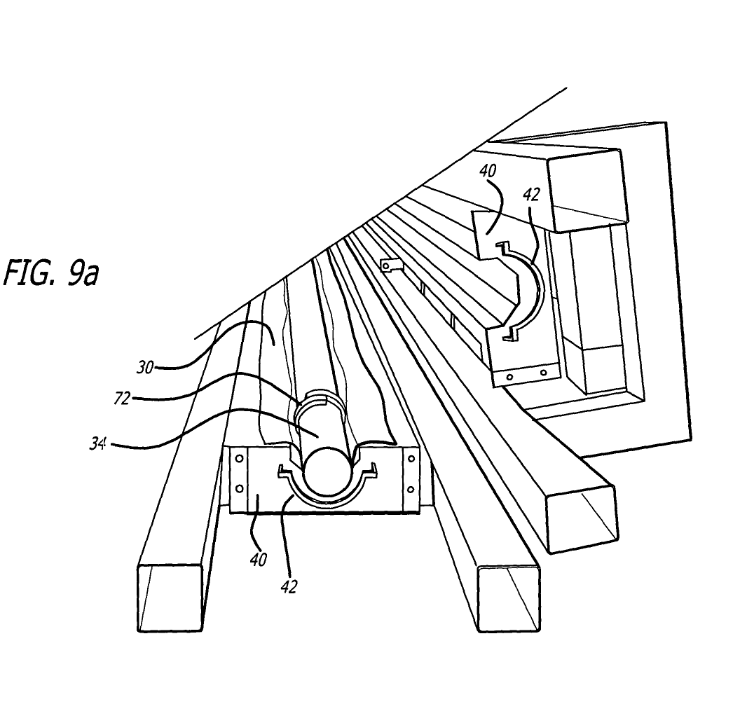

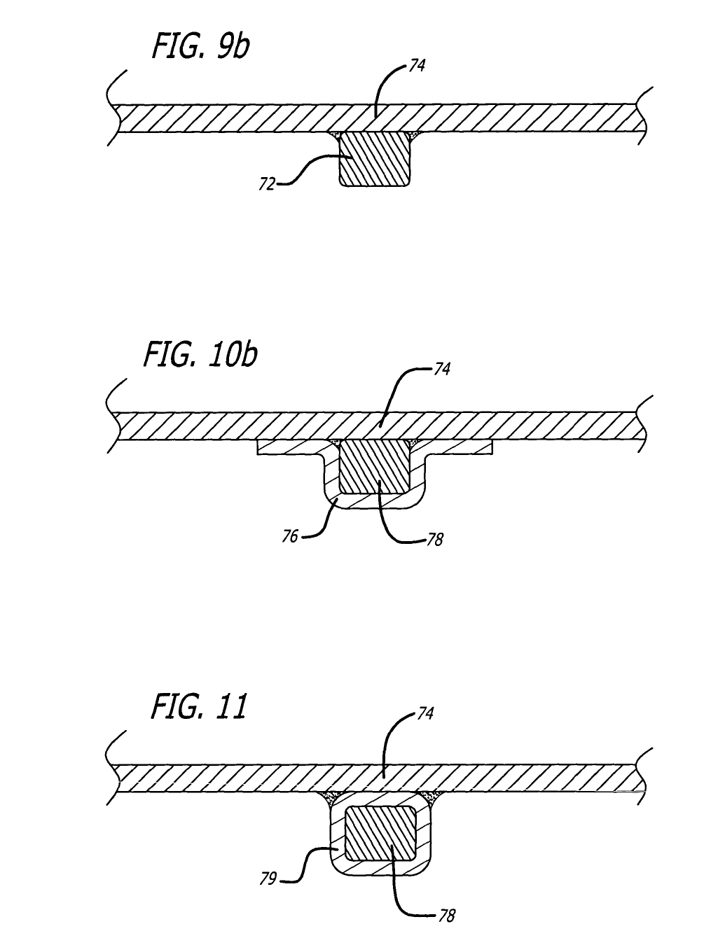

Now referring to FIGS. 9a and 9b, an alternate embodiment of the present invention may be seen. In this embodiment, the processing may be substantially identical to that hereinbefore described. However, before the layer or layers of mat and/or fabric 30 are folded over inflatable tube 34, a heavy cord 72 is wrapped around the inflatable tube 34 with the ends of the cord overlapping, preferably in side by side relationship (a closed loop could be used provided it was adequately stretchable along its length to expand in circumference as required when the inflatable tube is inflated). The cord 72 may be a single or multi-layer oven cord, a twisted rope-like cord or other forms of cord, as desired. When the processing is complete, the local cross-section of the pole will appear as shown in FIG. 9b, with the cord 72 being fully impregnated during the molding process and firmly bonded to the inside of the skin 74 of the finished pole to provide a reinforcing ring resisting collapse of the cross-section of the pole when subjected to high bending moments.

As an alternate, a local layer or layers 76 of mat and/or fabric may be wrapped around the inflatable tube 34 so that the ends thereof overlap, with a turn 78 of a filler material thereover, again the ends overlapping so that when the inflatable tube 34 is inflated, the ends will still somewhat overlap in the finished assembly. Thus in the finished assembly, a local cross-section of the finished pole will appear as shown in FIG. 10b, namely, with the filler material 78 spacing a layer or layers of fabric and/or mat 76 away from the inner surface of the main pole material 74, with the edges of layer 76 being firmly bonded to the pole, thereby providing a reinforcing ring, possibly of greater radial extent without of the use of greater amounts of material. In that regard, a suitable filler material 78 may be a closed cell foam, though any of many other materials may be used as desired.

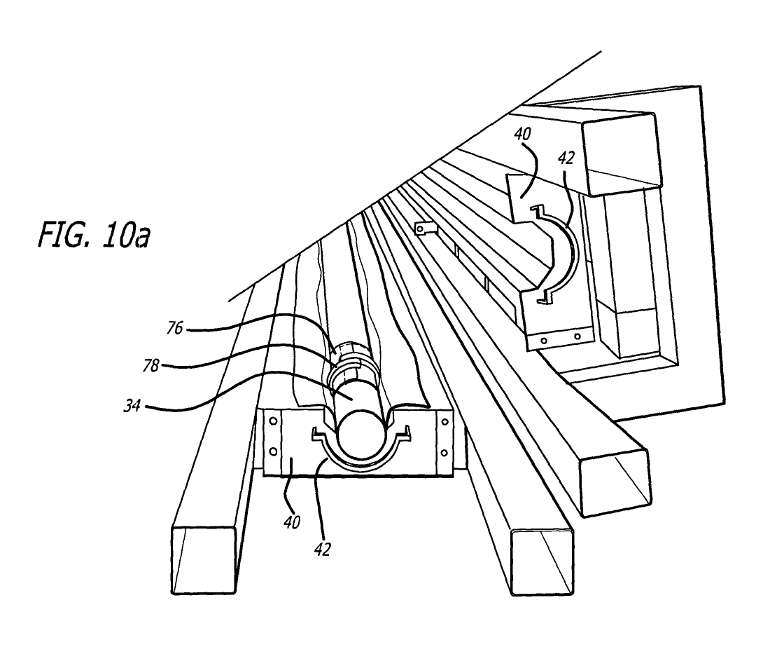

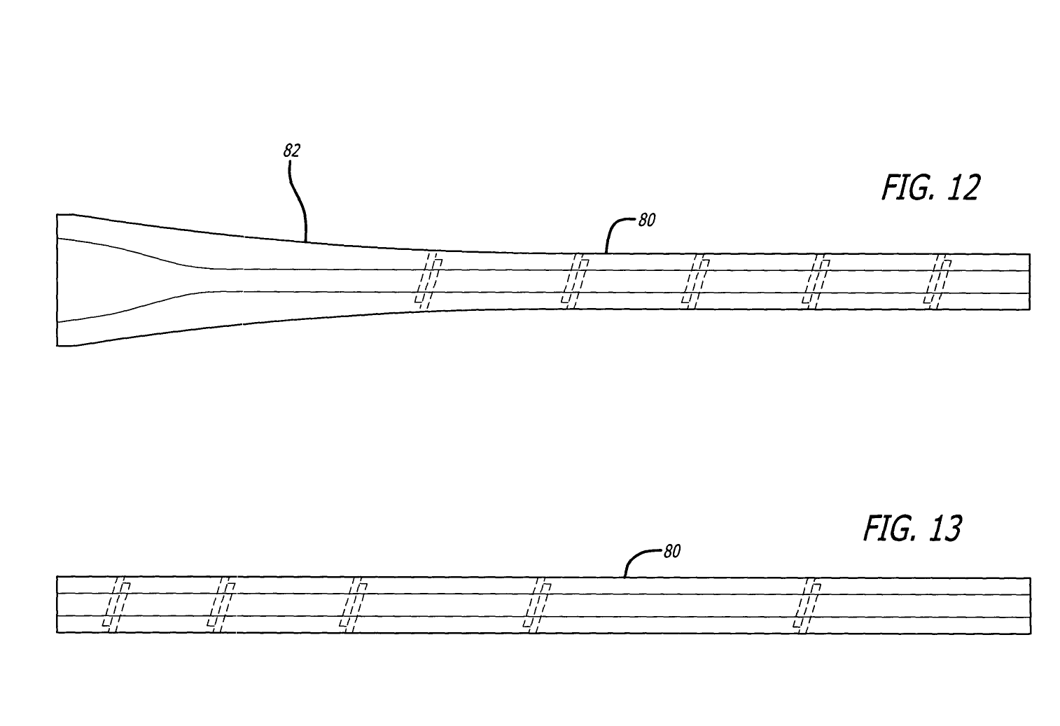

Finally, in FIG. 11, a single turn of a filler material 78 with a woven sock 79 thereover may be used, again preferably with a single turn with the ends overlapping so that in the finished pole the ends still somewhat overlap to be sure that the resulting reinforcing ring circumscribes the entire inside diameter of the pole. While multiple turns could be used, the same are not preferred (unless adequately stretchable longitudinally), as they may not expand as freely to the full diameter of the mold. However if multiple turns are desired, multiple single turns with overlapping ends would be preferred. The reinforcing rings formed by any of these methods may be evenly disposed along the length of the pole, such as is schematically illustrated in FIG. 12, or unevenly spaced to provide greater reinforcing in areas which may be subjected to greater bending moments, as is schematically illustrated in FIG. 13. Alternatively, the size and/or number of the reinforcing rings may be varied along the length of a pole.

Now referring to FIG. 12, an exemplary alternate application of the present invention may be seen. In particular, a side view of an 8 sided utility pole 80 having a taper 82 at one end thereof may be seen. Such a pole may be readily fabricated in accordance with the method hereinbefore described using an appropriately shaped mold and reinforcing material. The tapered end 82 may be a relatively gentle taper, with the extent of tapering inward of the inner periphery of the tapered section 82 being relatively limited in extent. Thus, the inflatable tube 34 used in the prior process normally would have sufficient elasticity to be usable in the fabrication of such a pole, or alternatively, the inflatable tube 34 in the previously described process may itself have a complementary taper toward one end thereof. Further, as a matter of convenience as opposed to necessity, the inflatable tube used to mold the pole 80 would normally be removed from the molded pole through the end of the molded pole having the larger inner periphery, though normally the inflatable tube 34 used in the prior process will collapse sufficiently when the fluid is pumped out of the tube to be withdrawn from either end of the pole.

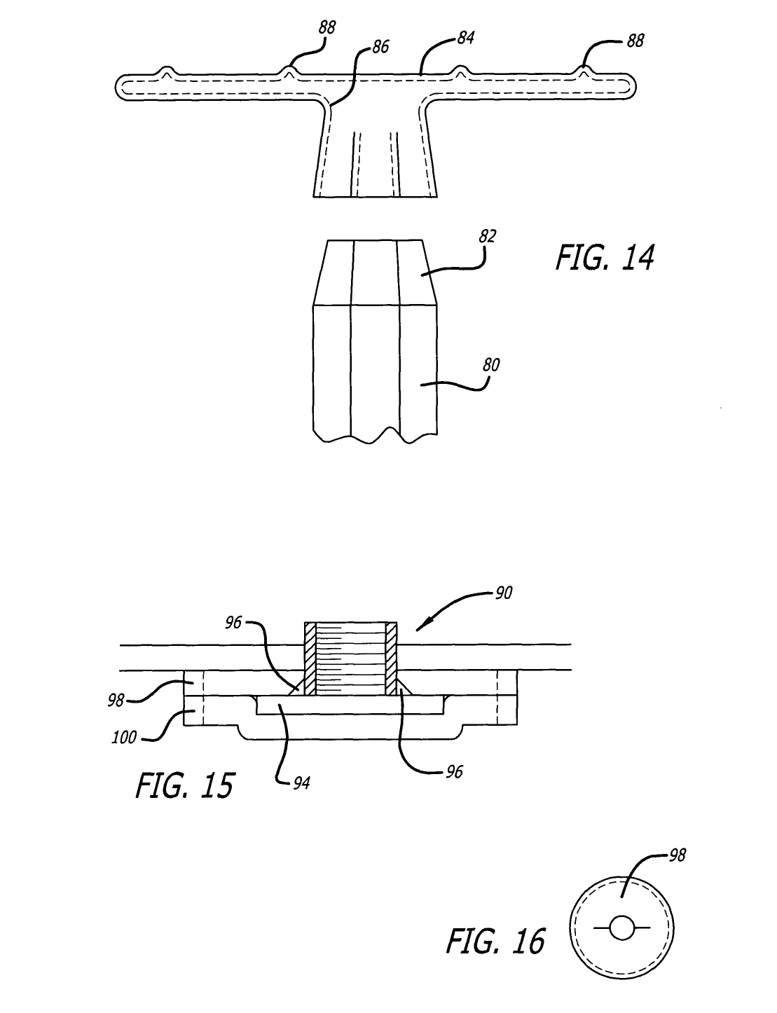

In any event, a crossarm for the utility pole 80, generally indicated by the numeral 84, is schematically shown in FIG. 14. The crossarm 84 may be molded using the basic hydraulic molding process hereinbefore described, differing only in the shape of the mold and the shape of the “inflatable tube” used to mold the crossarm. By way of example, the mold may be comprised of two mold halves with the “inflatable tube” being a generally T-shaped inflatable bladder of the general shape of, and typically of a smaller size than, the dashed line 86, the internal surface of a hollow crossbar. The lower end of the crossbar 84 has an internal taper matching the taper on the end 82 of the pole 80 so that the crossbar may be assembled to the pole in the field and attached to the pole. The attachment may be by such means as a small amount of adhesive on the closely fitting tapered surfaces, or alternatively, by the use of some alternate means such as mechanical fasteners, such as screws and the like.

It will be noted in FIG. 14 that the bladder may be a relatively simple T-shaped bladder, or alternatively, may have protrusions to assist in the forming of upper projections 88 for receipt of insulators thereon. In that regard, it is important to note that such a bladder may not necessarily have a monotonically decreasing cross-sectional area to the remote ends of the bladder to be easily removed from the molded product. In particular, such a bladder will substantially collapse when evacuated so as to be readily withdrawn from molded product regions having a larger internal cross-sectional area than other hollow regions through which the bladder must be withdrawn from the molded product.

In molding a product such as the crossarm 84 of FIG. 14, a single piece of high strength filament mat might be cut to the appropriate shape and wrapped around the bladder to provide reinforcing in all areas of the crossbar, and even a double layer in the junction between the horizontal and vertical portions of the crossbar (multiple layers, multiple pieces and/or woven fabric may also be used). Alternatively, one sheet of high strength filament might be placed in the lower mold half under the inflatable bladder, with a second piece placed over the inflatable bladder and overlapping the edges of the first piece, so that the two pieces will overlap in the finished product. After molding, products like crossarms (or poles) may be filled with a closed cell foam or other appropriate filler to add rigidity and strength, if desired. In other applications, weight may be desired, in which case fillers such as sand, concrete and the like may be used.

In the crossarm 84 illustrated in FIG. 14, the mounting regions for insulators are shown as upward projecting molded protrusions. Alternatively, the insulators themselves may be molded in place by including a provision for positioning the insulators relative to the mold so that the base of the insulators projects into the mold during the molding process. As a further alternative, given the susceptibility of insulators to damages one might mold insulator mounts into the crossarm, into which the insulators may be screwed or bolted. By way of example, FIG. 15 schematically illustrates a metal insulator mount 90 molded into the wall of a molded crossarm 84. The insulator mount may be an internally threaded member 92 fastened to a square or rectangular base 94 by welds 96. Preferably the sharp corners of the base 94 are broken, though the bladder may be further protected from the base 94 and the base better locked in place in the final molded product by using additional local layers of high strength filament, such as filaments layers 98 and 100. These may be located and held relative to the base 94 by first forming these layers into a pocket as shown in FIG. 16, and then inserting the base 94 into the pocket. As shown in FIG. 16, the pocket may be formed by cutting layers 98 and 100 into the desired complementary shapes, cutting a slit 102 and a central opening 104 in layer 98, the slit to allow the base 92 to pass there through, and the opening of a size to receive the threaded member 92. The two layers then can be sewn or cemented together to form the pocket. The insulator mount itself may be held relative to the mold by any of various ways, such as, by way of example, those commonly used for, or adapted from techniques used for holding inserts for molding into injection molded and other molded products.

The foregoing method of molding inserts into the products molded in accordance with the present invention is presented as exemplary only, as the details of any technique used may vary as much as the inserts themselves and is subject to the preferences of those controlling the molding. The general method described can be adapted by those skilled in the art to mold step mounts into the sides of utility poles, metal endcaps into the ends of structural columns and poles to mount or fasten other structures, or even to mold other mounts or entire structures directly onto the molded product being fabricated, whatever its shape.

In general, the present invention is intended for the molding of hollow composite products which have or can be provided with at least one temporary or permanent opening for withdrawing the inflatable bladder used in molding the product. In the exemplary embodiments disclosed, two piece molds having substantially symmetrical mold halves closing on a planar parting line are used, though this is not a limitation of the invention. Three or more piece molds, molds having a non-planar parting line and/or molds having collapsible inserts may be used, if desire. Similar variations will be apparent to those skilled in the art.

Thus while certain preferred embodiments of the present invention have been disclosed herein, such disclosure is only for purposes of understanding exemplary embodiments and not by way of limitation of the invention. It will be obvious to those skilled in the art that various changes in form and detail may be made in the invention without departing from the spirit and scope of the invention as set out in the full scope of the following claims.

1. A method of molding composite structures comprising:
providing a female mold defining the size and shape of the outer surface of the composite structure being molded, the female mold being openable and closable, and when closed, having at least one vent adjacent the top of the mold cavity;
with the mold open, disposing reinforcing material and an inflatable bladder in the mold, the reinforcing material being disposed in an amount and location to provide the desired reinforcement in the composite structure being molded, the bladder being configured to be inflatable to provide pressure on materials located between the bladder and the mold;
closing the mold;
putting a resin into the mold;
pressurizing the bladder to a first pressure with an incompressible fluid;
curing the resin;
depressurizing the bladder; and
opening the mold and removing the composite structure from the mold and the bladder from the composite structure.

2. The method of claim 1 wherein the bladder is depressurized and deflated.

3. The method off claim 1 wherein the resin is cured using heat.

4. The method of claim 3 wherein the bladder is inflated and pressurized to the first pressure using a heated incompressible fluid.

5. The method of claim 4 wherein the incompressible fluid is water.

6. The method of claim 1 wherein excess resin is poured into the mold, and the excess resin is expelled through the vent when the bladder is pressurized to the first pressure.

7. The method of claim 6 wherein the excess resin is recovered and used in a repeat of the method.

8. The method of claim 7 wherein the resin is cured using heat.

9. The method of claim 8 wherein the excess resin is recovered before being heated.

10. The method of claim 6 wherein the bladder is inflated to a predetermined condition before the resin is put in the mold.

11. The method of claim 10 wherein the predetermined condition is a second pressure that is less than the first pressure.

12. The method of claim 10 wherein the predetermined condition is a predetermined volume of fluid in the bladder.

13. The method of claim 1 wherein the resin is cured using RF energy.

14. The method of claim 1 wherein the reinforcing comprises high strength filament.

15. The method of claim 1 wherein the reinforcing comprises metal reinforcing.

16. The method of claim 1 wherein the reinforcing comprises wood.

17. The method of claim 1 wherein the bladder is deflated to a sub-atmospheric pressure before the mold is opened.

18. The method of claim 1 wherein the bladder is deflated to a sub-atmospheric pressure for removal from the composite structure.

19. The method of claim 1 wherein the reinforcing material is in the form of a mat or fabric.

20. The method of claim 19 wherein the mat or fabric differs in characteristics across an area of the mat or fabric in accordance with the variation in reinforcement desired in the composite structure.

21. The method of claim 1 wherein a layer of gel coat is sprayed onto the mold surfaces before disposing reinforcing material and an inflatable bladder in the mold.

22. The method of claim 21 wherein the layer of gel coat is sprayed onto the mold surfaces with the mold open.

23. The method of claim 1 wherein the bladder is a gum rubber bladder.

24. The method of claim 1 wherein the composite structure being molded is defined by only a part of the internal surface of the female mold so as to not comprise a hollow composite structure.

25. The method of claim 1 wherein the composite structure being molded comprises a hollow composite structure.

26. A method of molding elongate composite structures having an internal cavity comprising:
providing a female mold defining the size and shape of the outer surface of the composite structure being molded, the female mold being openable and closable, and when closed, having at least one vent adjacent the top of the mold cavity;
with the mold open, disposing reinforcing material and an inflatable bladder in the mold, the bladder being in the form of an elongate tube-like flexible member, the reinforcing material being disposed around the bladder and in an amount and location to provide the desired reinforcement in the composite structure being molded, the bladder being configured to be inflatable to provide pressure on materials located between the bladder and the mold;
closing the mold;
pouring a resin into the mold;
inflating and pressurizing the bladder with an incompressible fluid;
curing the resin;
depressurizing and deflating the bladder; and
opening the mold and removing the composite structure from the mold and the bladder from the composite structure.

27. The method of claim 26 wherein the mold is comprised of mold halves hinged together for opening an closing.

28. The method of claim 27 wherein the bladder extends through the length of the mold halves, and wherein the mold is closed at the ends thereof by bulkheads, at least one open end of the bladder being sealable within a respective bulkhead with respect to a source of incompressible fluid.

29. The method of claim 26 wherein the bladder is depressurized and deflated after depressurization.

30. The method off claim 26 wherein the resin is cured using heat.

31. The method of claim 30 wherein the bladder is inflated and pressurized to the first pressure using a heated incompressible fluid.

32. The method of claim 31 wherein the incompressible fluid is water.

33. The method of claim 26 wherein excess resin is poured into the mold, and the excess resin is expelled through the vent when the bladder is pressurized to the first pressure.

34. The method of claim 33 wherein the excess resin is recovered and used in a repeat of the method.

35. The method of claim 34 wherein the resin is cured using heat.

36. The method of claim 35 wherein the excess resin is recovered before being heated.

37. The method of claim 33 wherein the bladder is inflated to a predetermined condition before the resin is put in the mold.

38. The method of claim 37 wherein the predetermined condition is a second pressure that is less than the first pressure.

39. The method of claim 37 wherein the predetermined condition is a predetermined volume of fluid in the bladder.

40. The method of claim 26 wherein the resin is cured using RF energy.

41. The method of claim 26 wherein the reinforcing comprises high strength filament.

42. The method of claim 26 wherein the reinforcing comprises metal reinforcing.

43. The method of claim 26 wherein the reinforcing comprises wood.

44. The method of claim 26 wherein the bladder is deflated to a sub-atmospheric pressure before the mold is opened.

45. The method of claim 26 wherein the bladder is deflated to a sub-atmospheric pressure for removal from the composite structure.

46. The method of claim 26 wherein the reinforcing material is in the form of a mat or fabric.

47. The method of claim 46 wherein the mat or fabric differs in characteristics across an area of the mat or fabric in accordance with the variation in reinforcement desired in the composite structure.

48. The method of claim 26 wherein a layer of gel coat is sprayed onto the mold surfaces before disposing reinforcing material and an inflatable bladder in the mold.

49. The method of claim 48 wherein the layer of gel coat is sprayed onto the mold surfaces with the mold open.

50. The method of claim 26 wherein the bladder is a gum rubber bladder.

51. The method of claim 26 wherein the composite structure being molded is defined by only a part of the internal surface of the female mold so as to not comprise a hollow composite structure.

52. The method of claim 26 wherein the composite structure being molded comprises a hollow composite structure.

53. A method of molding utility poles comprising:
providing a female mold defining the size and shape of the outer surface of the utility pole being molded, the female mold comprising hinged mold halves openable and closable, and when closed, having at least one vent adjacent the top of the mold cavity;
with mold open, disposing reinforcing material and an inflatable bladder in the mold, the bladder being in the form of an elongate tube-like flexible member, the reinforcing material being disposed around the bladder and in an amount and location to provide the desired reinforcement in the utility pole being molded, the bladder being configured to be inflatable to provide pressure on materials located between the bladder and the mold;
closing the mold;
pouring a resin into the mold;
inflating and pressurizing the bladder with an incompressible fluid;
curing the resin;
depressurizing and deflating the bladder; and
opening the mold and removing the utility pole from the mold and the bladder from the utility pole.

54. The method of claim 53 wherein the bladder extends through the length of the mold halves, and wherein the mold is closed at ends thereof by bulkheads, at least one open end of the bladder being sealable within a respective bulkhead with respect to a source of incompressible fluid.

55. The method of claim 54 wherein the bladder is depressurized and deflated after depressurization.

56. The method off claim 53 wherein the resin is cured using heat.

57. The method of claim 56 wherein the bladder is inflated and pressurized to the first pressure using a heated incompressible fluid.

58. The method of claim 57 wherein the incompressible fluid is water.

59. The method of claim 53 wherein excess resin is poured into the mold, and the excess resin is expelled through the vent when the bladder is pressurized to the first pressure.

60. The method of claim 59 wherein the excess resin is recovered and used in a repeat of the method.

61. The method of claim 60 wherein the resin is cured using heat.

62. The method of claim 61 wherein the excess resin is recovered before being heated.

63. The method of claim 59 wherein the bladder is inflated to a predetermined condition before the resin is put in the mold.

64. The method of claim 63 wherein the predetermined condition is a second pressure that is less than the first pressure.

65. The method of claim 63 wherein the predetermined condition is a predetermined volume of fluid in the bladder.

66. The method of claim 53 wherein the resin is cured using RF energy.

67. The method of claim 53 wherein the reinforcing comprises high strength filament.

68. The method of claim 67 wherein the thickness of reinforcing material disposed in the mold decreases from one end of the mold to the other end of the mold.

69. The method of claim 68 wherein the mold defines a mold cavity having a cross section which decreases between first and second ends of the mold, and wherein the thickness of the reinforcing material is greater adjacent the end of the mold having the larger cross section.

70. The method of claim 67 wherein the mold defines a mold cavity having a cross section which decreases between first and second ends of the mold.

71. The method of claim 53 wherein the reinforcing comprises metal reinforcing.

72. The method of claim 53 wherein the reinforcing comprises wood.

73. The method of claim 53 wherein the bladder is deflated to a sub-atmospheric pressure before the mold is opened.

74. The method of claim 53 wherein the bladder is deflated to a sub-atmospheric pressure for removal from the utility pole.

75. The method of claim 53 wherein the reinforcing material is in the form of a mat or fabric extending the length of the mold and wrapping around the bladder for the longitudinal edges of the mat or fabric overlap so that the reinforcing material so that the longitudinal edges of the mat or fabric overlap in the final utility pole.

76. The method of claim 75 wherein the mat or fabric differs in characteristics across an area of the mat or fabric in accordance with the variation in reinforcement desired in the utility pole.

77. The method of claim 76 wherein the mat or fabric is heavier per unit area adjacent a first end of the mold than adjacent a second end of the mold.

78. The method of claim 77 wherein the cross sectional area of the mold is larger adjacent the first end of the mold than adjacent the second end of the mold.

79. The method of claim 78 wherein the cross sectional area of the mold is tapered along the length of the mold between the first end of the mold and the second end of the mold.

80. The method of claim 53 wherein a layer of gel coat is sprayed onto the mold surfaces before disposing reinforcing material and an inflatable bladder in the mold.

81. The method of claim 80 wherein the layer of gel coat is sprayed onto the mold surfaces with the mold open.

82. The method of claim 53 wherein the bladder is a gum rubber bladder.
